(19) United States
(12) Patent Application Publication
(10) Pub. No.: US 2012/0330470 A1
(43) Pub. Date: Dec. 27, 2012

(54) System and Method for Controlling Charging For Energy Usage

(75) Inventors: Johan Hjelm, Tokyo (JP); Michael Aström, Ronninge (SE); Andreas Fasbender, Aachen (DE)

(73) Assignee: TELEFONAKTIEBOLAGET LM ERICSSON (PUBL), Stockhom (SE)

(21) Appl. No.: 13/583,613

(22) PCT Filed: May 7, 2010
(86) PCT No.: PCT/JP2010/058237

§ 371 Date: Sep. 7, 2012

Related U.S. Application Data
(60) Provisional application No. 61/312,926, filed on Mar. 11, 2010.

(51) Int. Cl. G06F 1/26

(52) U.S. Cl. 700/286

(57) ABSTRACT

A system for controlling charging for energy usage is provided. The system may comprise a plurality of devices powered by electricity and a management network managing energy usage consumed by the plurality of devices. Each device of the plurality of devices may include a sensing unit for measuring energy usage consumed by the device, and a transmitting unit for transmitting the measurement of the energy usage to the management network. The management network may include a receiving unit for receiving the measurement transmitted by the transmitting unit, an identification unit for identifying a device for which the received measurement has been measured, and a charging unit for controlling charging to a user of the identified device based on the received measurement.

### TECHNICAL FIELD

The present invention relates to a system and method for controlling charging for energy usage.

### BACKGROUND

Today, energy such as power is delivered as if it were a fluid. This is also demonstrated in the way it is measured at the consumption point. Energy distribution systems exist that are in parallel used for data distribution, e.g. power over Ethernet. There are also systems which use power lines to distribute data. But the design of electrical and information systems typically differ wildly, the information systems normally being implemented on top of an electrical or optical system which uses very low energies (compared to the electrical systems) but require a much higher precision in terms of clock frequency, pulse width, modulation, etc.

The operator of power networks has no information about the power distribution to individual devices, even though there are attempts to use the central meter readings to identify usage patterns in individual devices. There is also no back-channel to individual devices, allowing feedback about consumption and potentially control of devices. There is furthermore no connection to other charging systems than those of the power company, which limits the business models to those supported in the charging systems of the power companies only. It is also typically not possible to connect other charging systems to those of the power company, enabling different business models than those currently supported. In particular, the charging systems of the power companies typically do not support prepaid business models.

Measurements over the data channel of whether the device is switched on or off are possible today, for instance, using UPnP events like discovery and timeout allow relatively easy detection of on/off phases of an appliance. But these do not provide any information about the actual energy consumption of the device.

### SUMMARY

According to an aspect of the invention, a system for controlling charging for energy usage is provided. The system may comprise a plurality of devices powered by electricity and a management network managing energy usage consumed by the plurality of devices. Each device of the plurality of devices may include a sensing unit for measuring energy usage consumed by the device, and a transmitting unit for transmitting the measurement of the energy usage to the management network. The management network may include a receiving unit for receiving the measurement transmitted by the transmitting unit, an identification unit for identifying a device for which the received measurement has been measured, and a charging unit for controlling charging to a user of the identified device based on the received measurement.

According to another aspect of the invention, a gateway for intermediating a plurality of devices powered by electricity and a management network managing energy usage consumed by the plurality of devices, is provided. The gateway may comprise a receiving unit for receiving a measurement of energy usage consumed by each device, an obtaining unit for obtaining an identity assigned for the device for which the received measurement is measured; and a transmitting unit for transmitting the received measurement and the obtained identity to the management network.

Further features of the present invention will become apparent from the following description of exemplary embodiments with reference to the attached drawings.

### BRIEF DESCRIPTION OF THE DRAWINGS

FIG. 1 illustrates an exemplary environment 100 including a system according to a first embodiment of the present invention.

FIG. 2 illustrates an exemplary block diagram of the device 111 according to the first embodiment.

FIG. 3 illustrates an exemplary block diagram of the gateway 113 according to the first embodiment.

FIG. 4 illustrates an exemplary block diagram of the PNAS 121 according to the first embodiment.

FIG. 5 illustrates an exemplary block diagram of the charging server 122 according to the first embodiment.

FIG. 6 illustrates an exemplary block diagram of the broker server 140 according to the first embodiment.

FIG. 7 illustrates an example of overall operations of the according to the first embodiment.

FIG. 8 illustrates an exemplary credit table 503.

FIG. 9 illustrates another exemplary environment 900 including a system according to the first embodiment of the present invention.

FIG. 10 illustrates an exemplary environment 1000 including a system according to a second embodiment of the present invention.

### DETAILED DESCRIPTION

Embodiments of the present invention will now be described with reference to the attached drawings. Each embodiment described below will be helpful in understanding a variety of concepts from the generic to the more specific. It should be noted that the technical scope of the present invention is defined by claims, and is not limited by each embodiment described below. In addition, not all combinations of the features described in the embodiments are always indispensable for the present invention.

It should be noted that while this document describes embodiments from the aspect of electricity, it can equally well be applied to handle other forms of continuous delivery, such as gas, steam, water, etc., when the usage can be reliably derived from the measurements by a relevant sensor, for example, energy usage sensor for electricity; flow sensor for water consumption, etc.

### First Embodiment

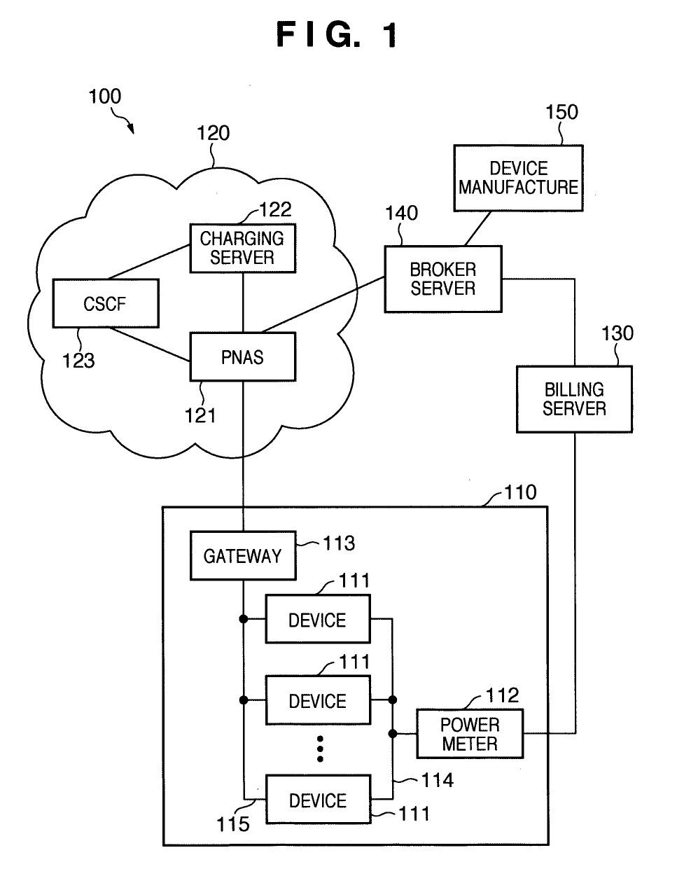

FIG. 1 illustrates an exemplary environment 100 including a system according to the first embodiment of the present invention. The environment 100 includes a local environment 110, a core network 120, a billing server 130, a broker server 140, and a device manufacture 150.

The local environment 110 includes a plurality of devices 111 and a power meter 112. The devices 111 are connected to the power meter 112 via a power distribution network 114. The device 111 is a device operating with electric power, such as a TV, a game console, an air conditioner, and so on. The local environment 100 according to this embodiment is any environment includes a plurality of devices powered by electricity. Examples of the local environment 100 are family dwelling, a factory, a school, and so on.

The power meter 112 measures the supplied electric power to the devices 111 and sends the information about the electric power consumed by the devices 111 to the billing server 130 using already established technologies. This may mean Sneakernet, or a mobile connection (where the power meter 112 comprises a mobile terminal using a data channel such as USSD in GSM, or similar in another mobile technology, or has a fixed connection).

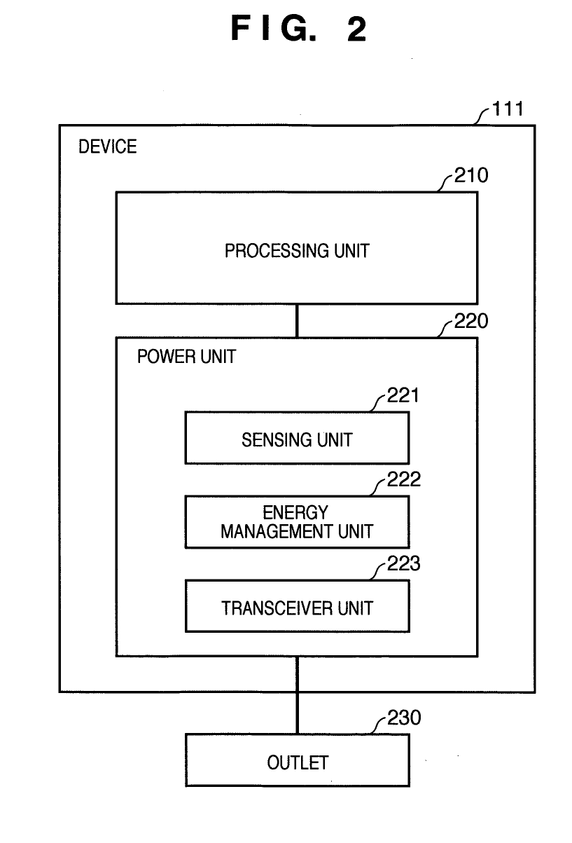

Each device 111 measures its consumed power usage and sends the measurement to the core network 120. FIG. 2 illustrates an exemplary block diagram of the device 111 according to this embodiment. The device 111 comprises a processing unit 210 and a power unit 220. The processing unit 210 may include a CPU and a memory, and performs specific operations of the device 111.

The power unit 220 comprises a sensing unit 221, an energy management unit 222, and a transceiver unit 223. The operations of the power unit 220 may be controlled by the processing unit 210, or a CPU (not shown) that the power unit 220 has. The power unit 220 may be built into the device 111, or externally attached to the device 111. The power unit 220 has a unique identity, which the core network 120 uses to identify the device 111.

The sensing unit 221 measures energy usage of the device 111, by measuring magnetic inductance, resistance over the electrodes, etc., for example. The sensing unit 221 may use electronics or magnetic induction to measure the flow of current (at a specified voltage) packaged in a tamper-proof manner and the consumption of electricity.

The energy management unit 222 controls energy delivery to the processing unit 210. This may be realized technically in a binary fashion (switch on/off), or using phase strangling (i.e. delivery of only one phase of a three-phase system) or brownout (lowering the voltage and/or the current) delivered.

The transceiver unit 223 is used to communicate with the core network. For example, the transceiver unit 223 sends the measurement of the energy usage measured by the sensing unit 221 to the core network 120, and receives an instruction for energy management from the core network 120.

The local environment 110 may also include a gateway 113. The devices 111 and the gateway 113 are connected via an information network 115. The information network 115 is used by the user for receiving and transmitting information, such as a home network and an office network. In this embodiment, the information network 115 and the power distribution network 114 are separate. The gateway 113 is an application layer gateway device between the core network 120 and the information network 115. The transportation and authentication of messages between the core network 120 and the information network 115 are intermediated by the gateway 113 and secured by security mechanisms provided by the core network 120.

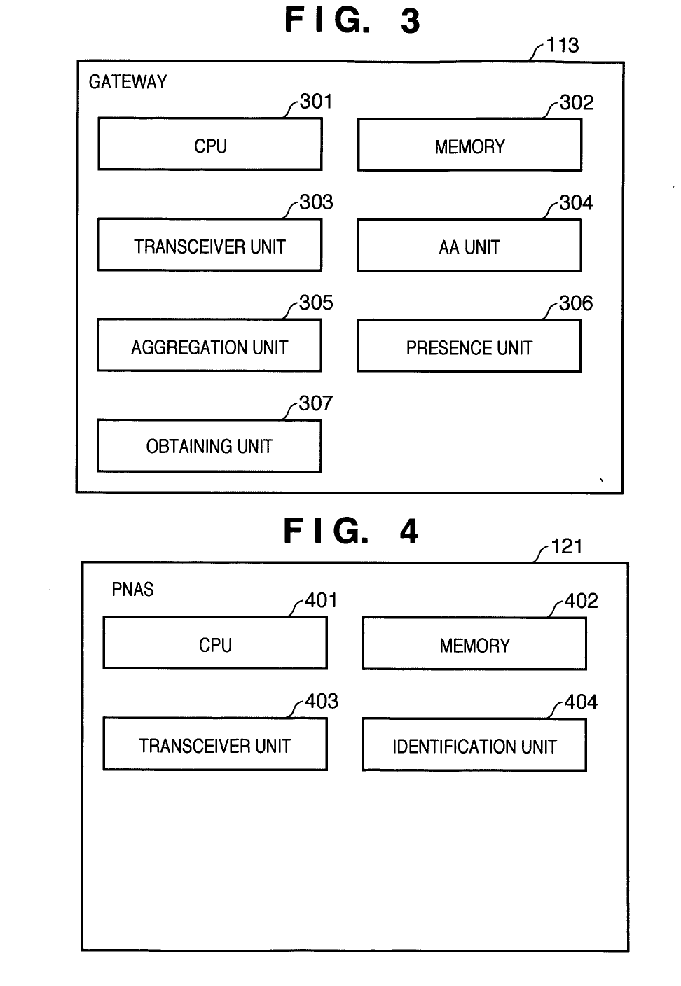

FIG. 3 illustrates an exemplary block diagram of the gateway 113 according to this embodiment. The gateway 113 comprises a CPU 301, a memory 302, a transceiver unit 303, an AA (authentication and authorization) unit 304, an aggregation unit 305, a presence unit 306, and an obtaining unit 307. The CPU 301 controls overall operations of the gateway 113. The memory 302 stores computer programs and data used for operations of the gateway 113.

The transceiver unit 303 communicates with the devices 111 and the core network 120. The transceiver unit 303 may communicate with the power unit 220 using a proprietary or semi-proprietary protocol such as WiFi, ZigBee or similar. Other cases involving similar protocols to fulfill the same functions are also possible. The transceiver unit 303 may communicate with the core network 120 using GSM, LTE, or a fixed connection to a managed network (such as IMS) or an unmanaged network, if functionalities of the core network 120 have been implemented in the unmanaged network. The transceiver unit 303 may provide the mediation between the information network 115 and the core network 120. The transceiver unit 303 may translate one network protocol into another and any protocols. For example, if the sensing unit 221 uses 6LowApp, then the transceiver unit 303 can translate the signaling to SIP for the core network 120.

The AA unit 304 manages authentication and authorization of an appliance or a group of appliances to use the network resources (such as energy supply). The power unit 220 and the gateway 113 may be constructed in a trusted or tamper-proof manner. This implies that in particular the AA unit 304 cannot be manipulated by an unauthorized party, either physically or logically. An example of this is the implementation of the trusted computing environment defined by the Trusted Computing Group. The messages between the power unit 220 and the gateway 113 may also be encapsulated so that the communication can not be accessed by unauthorized parties.

The trust can be ensured end-to-end, since the data can be encrypted inside the messages. Actually, this can ensure a secondary level of trust: If the messages from the device 111 is encrypted with the key of the device 111, and the messages when passing the gateway 113 is encrypted a second time with the key of the gateway 113, then the receiver is assured that the messages come from that device in that particular house.

The aggregation unit 305 aggregates the measurements from the devices 111 so as to report the measurements to the core network 120 on an aggregated basis for a group of devices 111, or from single device 111.

The presence unit 306 pushes the measurements from the devices 111 to the core network 120, for example, using IMS Presence (a push (publish/subscribe) mechanism).

The obtaining unit 307 obtains a unique identity from the power unit 220 of each device 111. When the device 111 does not have a unique identity, the obtaining unit 307 may provide the device 111 with a globally device identity. This can be done in various ways, for example, by mapping an existing identity to a global identity (for example, by mapping a remote SIM to a UUID, or similar). The gateway 113 may be used to expose the consumed/produced electricity on DLNA or other similar (for example, HDMI) devices.

The device 111 may communicate with the core network 120 directly, that is without the gateway 113, by LTE and IMS, for example. Using the on and off phases by generated UPnP events by, for example, leveraging analysis software such as a DLNA Probe, it is possible to create an estimate for the energy usage provided that the average usage of the device 111 does not vary over time, and is known in advance. This can for example be stored in a collaboratively created database of device characteristics, such as WURFL (described in http://www.wurflpro.com/), which today only applies to mobile devices, but equally well could apply to consumer devices. It is also possible that a trusted third party such as Consumer Report or similar creates such a database.

The core network 120 includes a PNAS (Personal Network Application Server) 121, a charging server 122, and a number of servers such as a CSCF 123 for controlling flow of information. The core network 120 is typically managed by a network operator and may be controlled by, for example, IMS (the Internet Multimedia Subsystem as defined by 3GPP) for the management of authentication, authorization, etc. The communication inside the core network 120 may use ISC and the other protocols defined in 3GPP.

Note that the servers in the core network 120 may interact with the power network, that is, the core network may not be connected to the power distribution network 114, but interfaced to the power distribution network 114 through a dedicated server or directly through the charging system. The core network 120 in one embodiment is the same as the core network 120 for a mobile network or other network operators. This includes, for example, the connection between charging server 122 and authorization functions. The core network 120 may also contain functions for subscription management, etc.

The PNAS 121 is an IMS enabler that allows exposing information about the devices 111. FIG. 4 illustrates an exemplary block diagram of the PNAS 121 according to this embodiment. The PNAS 121 comprises a CPU 401, a memory 402, a transceiver unit 403, and an identification unit 404. The CPU 401 controls overall operations of the PNAS 121. The memory 402 stores computer programs and data used for operations of the PNAS 121.

The transceiver unit 403 communicates with other apparatuses such as the devices 111, the gateway 113, the charging server 122, and the broker server 140. The transceiver unit 403 may provide these apparatuses with interaction with a trusted party. In case where the core network 120 is an IMS network, the transceiver unit 403 may communicate with the charging server 122 over the standardized Rf and Ro interfaces. The transceiver unit 403 may provide the mediation between the charging server 122 and the gateway 113 (or the device 111) to ensure that the information received is translated to a format which the charging server 122 can receive. The transceiver unit 403 may also provide the mediation between the broker server 140 and the gateway 113 (or the device 111) for the same reason.

The identification unit 404 identifies a device 111 for which the measurement has been measured based on the unique identity of the device 111.

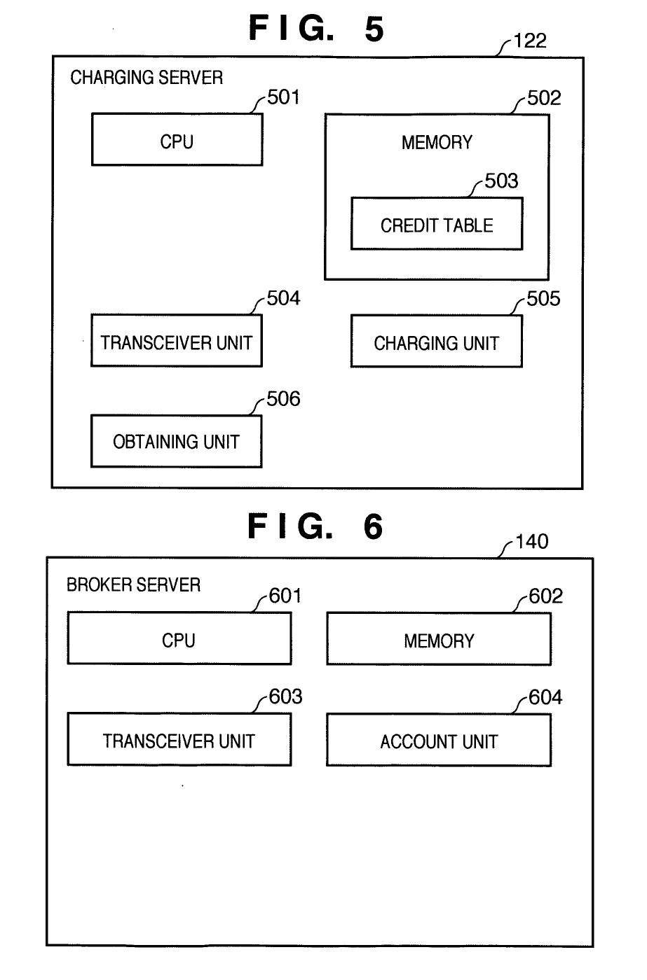

The charging server 122 controls charging for energy usage of each device 111. FIG. 5 illustrates an exemplary block diagram of the charging server 122 according to this embodiment. The charging server 122 comprises a CPU 501, a memory 502, a transceiver unit 504, a charging unit 505, and an obtaining unit 506. The CPU 501 controls overall operations of the charging server 122. The memory 502 stores computer programs and data used for operations of the charging server 122, and a credit table 503. Details of the credit table 503 will be described later.

The transceiver unit 504 communicates with the PNAS 121. The transceiver unit 504 may communicate with the other servers over the standardized Rf and Ro interfaces. The charging unit 505 controls charging for energy usage of each device 111 to the user of the devices 111 based on the measurements. The charging unit 505 may control the supply of electricity, which means that those who have not paid can have their power unit 220 switched off, and will not receive any credit, hence either paying the full amount or in some embodiments not receiving any electricity. The obtaining unit 506 obtains a credit intended for a device.

The billing server 130 computes the debit of the customers account for the consumed electricity based on the measurements from the power meter 112. The billing server 130 is typically managed by a power company. It should be noted that one embodiment of the invention includes the use of centralized electricity meters. As long as these electricity meters are connected to an operator of an energy network (which may be the same as who provides the power unit 220, or a different one who has an agreement with the owner of the central electricity meter), the usage of the dedicated power controller can be subtracted from the overall usage of the household, and charged separately to a different party.

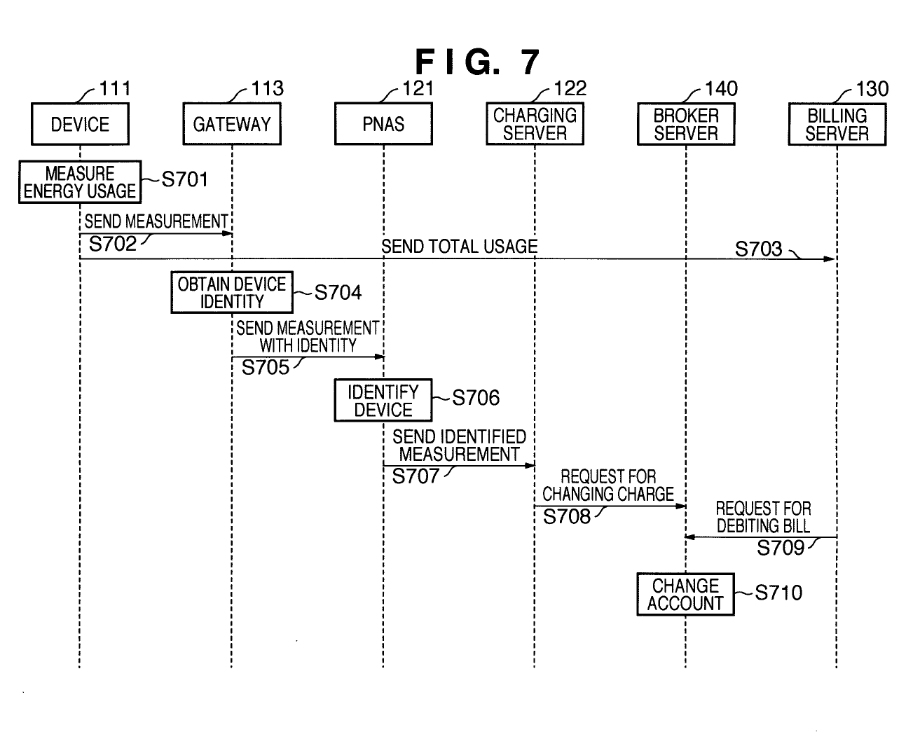

The broker server 140 manages an account of a user of the device 111. Electric bills for the energy usage are debited from the account. In this embodiment, the core network 120 and the billing server 130 are connected via the broker server 140 for the sake of convenience. FIG. 6 illustrates an exemplary block diagram of the broker server 140 according to this embodiment. The broker server 140 may be managed by a bank, a payment aggregator, or the operator or the power company themselves. The broker server 140 may be managed by a third party, such as a different operator with whom a third user has bought airtime, and who can sell the airtime to the network operator and generate the required credit, or a separate actor who performs this role. The communication between the broker server 140 and the other servers can be implemented as web services or other methods with similar functionality. The broker server 140 comprises a CPU 601, a memory 602, a transceiver unit 603, and an account unit 604. The CPU 601 controls overall operations of the broker server 140. The memory 602 stores computer programs and data used for operations of the broker server 140. The transceiver unit 603 communicates with other apparatuses such as the PNAS 121 and the billing server 130. The account unit 604 manages accounts of users.

FIG. 7 illustrates an example of overall operations of the according to this embodiment. The CPU included in each server and device executes computer programs stored in memory of each server and device to process these operations.

In Step S701, the processing units 210 of the devices 111 start consuming electricity. The sensing unit 221 of each device 111 measures the energy usage consumed by the processing unit 210. The power meter 112 measures total power usage of all of the devices 111 connected to the power distribution network 114. Note that the sensing unit 211 measures the energy usage per each device 111 and the power meter 112 measures the energy usage for whole devices 111.

In Step S702, the transceiver unit 223 of each device 111 sends the measurement, or the sensor readings, to the gateway 113. This can be done over a variety of protocols. There are specially designed protocols for this, as well as standards such as 6LowPan, which are designed for use over the network interfaces which are used for this, for example the ZigBee wireless network. The transceiver unit 223 may send the measurement to the PNAS 121 directly if the transceiver unit 223 can communicate with the PNAS 121. The transceiver unit 223 may accompany the measurement with the identity of the device 111. In Step S703, the power meter 112 sends the total usage to the billing server 130.

In Step S704, the obtaining unit 307 of the gateway 113 obtains the identity of each device which sends the measurement to the gateway 113. The device identity may be received together with the measurement.

In Step S705, the transceiver unit 303 of the gateway 113 sends the measurement accompanied with the identity of the device 111 to the PNAS 121. The aggregation unit 305 of the gateway 113 may aggregate the measurements from the plurality of devices 111. The aggregation unit 305 may also collate the measurements to send the information at certain times or threshold values, or depending on other consumption-related parameters, for example the currently logged in users. This allows grouping of energy consumption, for example for better tracking (how much energy do the different family members consume). Grouping can be done on the level of individuals, as well as reflecting different device types, for example. This grouping may be a feature of the IMS system. When implemented in systems not using IMS, there may be equivalent means of implementing grouping of energy consumers. This step may be done at other server, for example, at the PNAS 121. The communication between the gateway 113 and the PNAS 121 of the measurement can be done using IMS Presence.

In Step S706, the identification unit 404 of the PNAS 121 identifies a device 111 for which the received measurement has been measured. In Step S707, the transceiver unit 403 of the PNAS 121 sends the identified measurement and the corresponding device identity to the charging server 122. This may be done over the Rf and Ro interfaces of the charging server 122.

In Step S708, the charging unit 505 of the charging server 122 determines charging information based on the received measurement and the transceiver unit 504 of charging server 122 sends the charging information to the broker server 140 directly or via the PNAS 121. The charging information includes a credit towards the power usage. How the charging unit 505 determines the charging information will be described later. The charging unit 122 may format the charging information according to business rules controlled by the agreement between the operator managing the broker server 140 and the other parties.

In Step S709, the billing server 130 determines billing information based on the received total power usage of the devices 111 and sends the billing information to the broker server 140. The billing information includes a debit of the user owning the devices 111. The billing information may be controlled by the same conditions as the relation between the operator managing the broker server 140 and the operator managing the PNAS 121.

In Step S710, the account unit 604 changes the balance of the user owning the devices 111 based on the charging information and the billing information. The account unit 604 may subtract the money amount described in the billing information from the balance of the user, while may add the money amount described in the charging information to the balance of the user. The account unit 604 may send a bill for the reminder to the user, or a delegate thereof. It is also possible for users to “top up” their own or another users account. When the balance of the account is not enough for paying the bill, the account unit 604 may request the energy management unit 222 of the device 111 to stop or decrease energy delivery for the device 111.

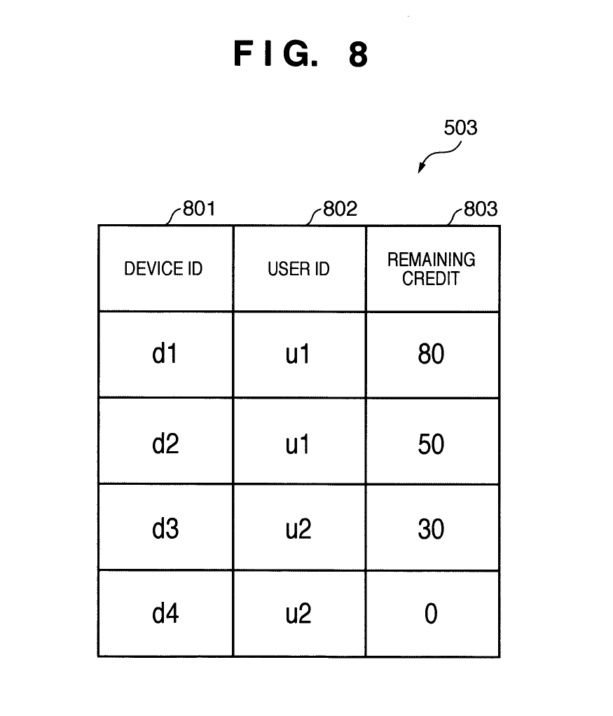

How the charging unit 505 determines the charging information is now described with reference to FIG. 8. FIG. 8 illustrates an exemplary credit table 503. The credit table 503 lists remaining credit for each device 111. The column “DEVICE ID” 801 describes a unique identity of the device 111. The column “USER ID” 802 describes a unique identity of the user owning the devices 111. The column “REMAINING CREDIT” 803 describes a money amount of remaining credit for each device 111. The remaining credit 803 may be increased when the obtaining unit 506 obtains a request from the user or someone (who gives the user the device, for example) who prepays for the particular device. The device manufacture 150 may sell a device with a rebate coupon and the purchaser of the device may increase the remaining credit 803 for the device using the rebate coupon.

The charging unit 505 decreases the remaining credit 803 for the device when the measurement for the power usage consumed by the device is received. For example, when the obtaining unit 506 receives a measurement consumed by the device “d1”, the charging unit 505 subtracts the money amount corresponding to the received measurement from the remaining credit of the device “d1”. In addition to that, the charging unit 505 includes the money amount corresponding to the received measurement (that is, a described amount of the remaining credit 803) into the charging information so as to request the broker server 140 to increase the balance of the user “u1” of the device “d1”. When the money amount corresponding to the received measurement exceeds the remaining credit 803, the charging unit 505 includes all amount of the remaining credit 803 into the charging information and sets the remaining credit 803 for the device to zero.

The credit table 503 may be changed by energy trading. For example, if the user “u2” (the user whose user id 802 is “u2”) does not use a device (such as device “d3”) with lifetime contract any longer, the user “u2” can request this chunk to be used for other device (such as device “d4”), or pass the chunk to his friend (such as the user “u1”). In this case, the charging unit 505 moves some or all of the remaining credit 803 of one device to the remaining credit 803 of another. It also allows, where this is legally possible, the trading of other virtual commodities, for example, airtime, against electricity. As is well known, the trading of airtime using prepaid accounts today functions as an important means of exchange in Africa, where the airtime is exchanged for money at the location of the receiver. If this was automated, it could also be exchanged for electricity). In such situations, it may be beneficial to allow for the connection of a mobile terminal to the core network 120.

Some variations of this embodiment will now be described. The network operator of the core network 120 may provide an integrated credit towards the charging server 122 for all the devices 111 which the user has purchased, when the user has configured the gateway 113 or the PNAS 121 to filter the measurements in that way. This implies the PNAS 121 has to integrate the measurements from the different devices 111 that relate to the user, and present all of the measurements to the charging server 122.

When there is no central power meter 112 for the local environment 110, but each device 111 has its own power meter (potentially built in), the charging for power usage can be done from the operator, who will keep track of the usage of electricity from the PNAS 121.

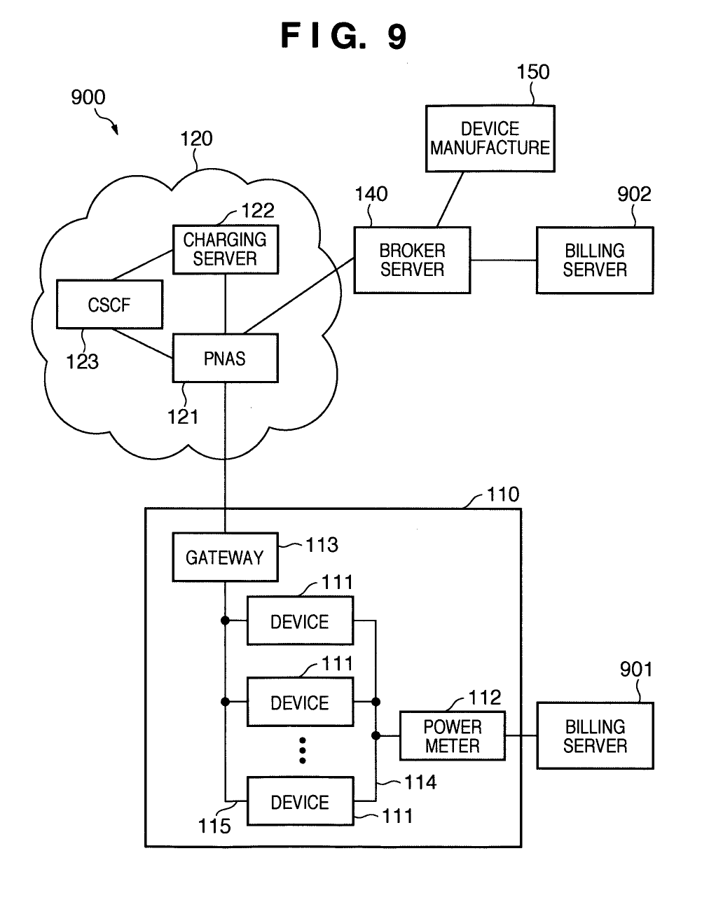

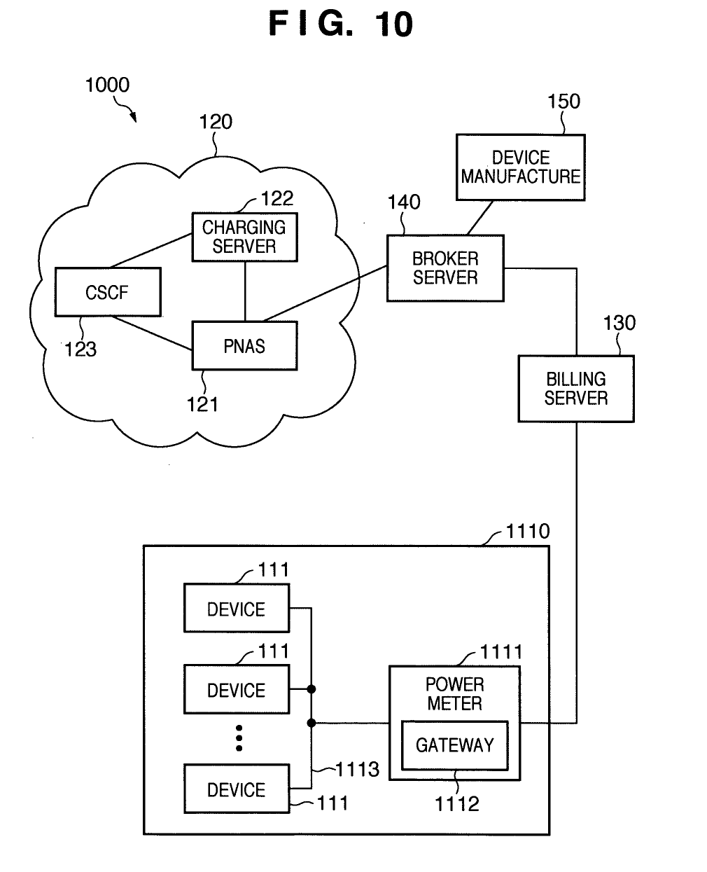

The devices 111 may be includes a device producing electricity, for instance a home fuel cell whose primary task is producing heat, and the produced electricity may be sold to a different power company than the one which maintains the main power line into the building (this may be mandated by contractual relationships, city bylaws, or similar). In this case, the sensing unit 221 in the device 111 producing electricity measures an amount of power produced by the device 111. This situation is illustrated in FIG. 9. FIG. 9 illustrates another exemplary environment 900 including a system according to the first embodiment of the present invention. In this situation, the billing server 902 may generate a credit in the broker server 140, that is independent of the billing relationship with a Power Company maintaining the power meter 112 and sending bills through its own mechanisms using the billing server 901.

Furthermore, the energy production may be predictively controlled. Since the patterns of consumption will be known by the PNAS 121 after some time of operation, the patterns can be used to predict electricity consumption in advance, and control the generation of electricity.

This embodiment has the following advantages. Note that some embodiments may not achieve some of the following advantages, but such embodiments are not excluded from the scope of the present invention.

According to this embodiment, other actors than the power company can interact with the payment for electricity, enabling different business models and mechanisms, for instance prepaid electricity or advertising-supported electricity.

Furthermore, this embodiment is not tied to the electricity provider, for example, Vattenfall or TEPCO. If deployed in a completely distributed fashion, the invention enables the user to choose electricity providers at device level, something which is not possible today.

For the vendor of the devices, the advantage is that the credit of the charging is directly applied to the purchased device. This can be handled on an individual (per individual device) basis. This will also provide feedback on the usage of the devices, since the information which can be received from the sensors are much richer than traditional usage information obtained from the electricity network. This may be handled in various ways, for instance automatically provided to the owner of the account; or brokered through some specialized mechanism or entity.

### Second Embodiment

In this embodiment, which is illustrated in FIG. 10, the control channel for the power unit 220 is integrated with the power distribution network 1113. FIG. 10 illustrates an exemplary environment 1000 including a system according to the second embodiment of the present invention. In FIG. 10, the same or similar elements to those in FIG. 1 are indicated with the same reference numeral. The variations described in the first embodiment may be applied to this embodiment. This embodiment enables more immediate control of the energy production. An integrated control plane combines network and energy control, and a set of servers are integrated in the customer management system of the operator of the energy distribution network 1113, with a dedicated control plane protocol. The power unit 220 may communicate directly with the core network 120, using for instance the data channel of a mobile network, such as USSD in GSM or LTE, where the power unit 220 itself is a mobile terminal. The gateway function 1112 can be integrated with a power meter 1111 for the household, but this can also be a separate function.

This embodiment may work with Powerline networks; power distribution without control channel but the control channel in ZigBee and Internet; power over Ethernet; and so on (incidentally, making charging for Power over Ethernet possible by other means than those which relate to the data packets).

When this embodiment applies, the flow will be slightly different from the flow in the first embodiment. Both energy and information will pass over the same channel, which implies that the flow of both energy and information can be filtered and managed in the power meter 1111 with gateway functions 1112.

In the first embodiment, control messages are sent from the power meter 112 to the gateway 113 by way of the PNAS 121, and then to the devices 111, changing their behavior (for instance, decreasing the temperature in the refrigerator; lowering the heat in the combined boiler and generator). In the second embodiment, the control messages can be sent directly from the power meter 1111 with the gateway function 1112 as soon as fluctuations are detected.

This embodiment has the following advantages. Note that some embodiments may not achieve some of the following advantages, but such embodiments are not excluded from the scope of the present invention.

This embodiment applies in particular when the user has an electricity meter which is connected to equipment for local production of electricity, for instance solar cells, wind power plant, etc. In those cases, the sensors for the power consumption and the power production are both connected to the power meter.

In situations where power is not fed out on the network, but kept within the home network, this still enables the identification of which device consumes and which device produces how much power, and it allows for the user to be credited for power produced, even when this is not fed onto the network. This may be desirable in situations like the Swedish distribution network, where very high fees are charged for small energy producers who want to sell energy to the distribution companies. Furthermore, it allows the power meter itself to identify how much energy was actually produced and consumed, instead of just measuring how much energy was purchased from the power company.

This embodiment is also potentially optimized to handle fluctuations from connected appliances. Integration can be controlled through the use of certified control boxes.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1-14. (canceled)

15. A system for controlling charging for energy usage, comprising a plurality of devices powered by electricity and a management network managing energy usage consumed by the plurality of devices, each device of the plurality of devices including:
a sensing unit for measuring energy usage consumed by the device,
a transmitting unit for transmitting the measurement of the energy usage to the management network, and
an energy management unit for changing energy delivery for the device in response to a request from the management network, and the management network including:
a receiving unit for receiving the measurement transmitted by the transmitting unit,
an identification unit for identifying a device for which the received measurement has been measured, and
a charging unit for controlling charging to a user of the identified device based on the received measurement.

16. The system according to claim 15, further comprising an obtaining unit for obtaining credit intended for the identified device, wherein the charging unit manages credit per each device of the plurality of devices and transfers, based on the received measurement, the credit to an account used for debit of electric bill of the identified device.

17. The system according to claim 15, wherein the energy management unit changes energy delivery for the device based on balance of the account.

18. The system according to claim 15, wherein
the device is assigned an identity,
the transmitting unit transmits the measurement together with the identity, and
the identification unit identifies the device by use of the identity.

19. The system according to claim 15, wherein the plurality of devices include a device for producing energy, whose sensing unit measures energy produced by the device.

20. The system according to claim 15, further comprising a gateway for intermediating the communication between the plurality of devices and the management network.

21. The system according to claim 20, wherein the gateway groups the plurality of devices and transmits the measurement per each group.

22. The system according to claim 20, wherein
the management network is an IMS network,
the gateway is an IMS gateway, and
the communication between the IMS network and the IMS gateway is conducted by use of authentication and authorization function.

23. The system according to claim 22, wherein the charging unit communicates with the account over Rf and Ro interfaces.

24. The system according to claim 22, wherein the gateway transmits the measurement by use of IMS presence function.

25. The system according to claim 15, wherein the management network is an unmanaged network.

26. The system according to claim 15, wherein the transmitting unit transmits the measurement via a power line through which the device is powered.

27. A device powered by electricity, comprising:
a sensing unit for measuring energy usage consumed by the device,
a transmitting unit for transmitting the measurement of the energy usage to the management network, and
an energy management unit for changing energy delivery for the device in response to a request from a management network which manages energy usage consumed by the device.

28. A method for controlling charging for energy usage in a system comprising a plurality of devices powered by electricity and a management network managing energy usage consumed by the plurality of devices, the method comprising:
measuring, by a sensing unit of each device, energy usage consumed by the device,
transmitting, by a transmitting unit of the device, the measurement of the energy usage to the management network,
changing, by an energy management unit of the device, energy delivery for the device in response to a request from the management network,
receiving, by a receiving unit in the management network, the measurement transmitted by the transmitting unit,
identifying, by an identification unit in the management network, a device for which the received measurement has been measured, and
controlling, by a charging unit in the management network, charge to a user of the identified device based on the received measurement.
